(19) United States
(12) Patent Application Publication
(10) Pub. No.: US 2005/0086686 A1
(43) Pub. Date: Apr. 21, 2005

(54) Digital broadcast message system

(76) Inventor: James Thomas, Fort Myers, FL (US)

Correspondence Address: William E. Noonan, Post Office Box 07338, Fort Myers, FL, 33919, US

(21) Appl. No.: 10/971,274

(22) Filed: Oct. 21, 2004

Related U.S. Application Data
(60) Provisional application No. 60/513,440, filed on Oct. 21, 2003.

(51) Int. Cl. H04N 7/025; H04N 7/173; H04M 11/00; H04N 7/16; H04N 7/10; H04N 7/087; H04N 5/445; H04N 7/084

(52) U.S. Cl. 725/33; 725/110; 725/112; 725/136; 348/468; 348/473; 348/563

(57) ABSTRACT

A digital broadcast message system includes a network of high-resolution display panels capable of broadcasting video and photographic images, as well as text. Each of the display panels is mounted proximate a roadway or other public venue and is optically visible to persons traveling along the roadway or otherwise in the public venue. The display panels feature solid-state electronic components, including LED clusters. The image projected by each display panel is controlled by a controller, which features a computer programmed to provide selected digital signals to the respective display panels. The system is particularly intended for use in broadcasting information concerning national (homeland) security and other areas of public interest.

### RELATED APPLICATION

This application claims the benefit of U.S. Provisional Patent Application Ser. No. 60/513,440 filed Oct. 21, 2003.

### FIELD OF THE INVENTION

This invention relates to a digital broadcast messaging system and, more particularly, to a system for directing high-resolution photographs and video messages from a control center to a plurality of outdoor and/or indoor display panels.

### BACKGROUND OF THE INVENTION

Homeland security has recently become a foremost national concern. Notices concerning homeland security are typically published by broadcast media (i.e. television and radio), as well as by print media. Nonetheless, no current system exists which relays crucial national security information, as well as other extremely time sensitive information of a public nature (e.g. information concerning missing persons, natural disasters and wanted persons) to members of the public who do not have access to and are not currently paying attention to broadcast and print media. This may include a large number of persons traveling by automobile along public roadways. Similarly situated are persons located at mass transportation facilities such as airport terminals, train stations and bus stations, as well as other public venues such as stadiums and arenas. An urgent need exists for a centralized system for relaying such information in a highly visible and virtually instantaneous manner to such members of the public. A need also exists for a system for efficiently funding and operating this type of messaging system. Although some public messaging systems are currently available, such as the “Amber Alert”, these systems do not transmit high quality photographic and video images.

### SUMMARY OF THE INVENTION

It is therefore an object of the present invention to provide an outdoor digital broadcast message system that allows the federal government or other centralized agency to transmit high quality photographic and video messages to members of the public traveling by automobile or otherwise out of doors at a public venue.

It is a further object of this invention to provide a system for instantaneously updating the public concerning important and time sensitive national and regional issues, such as homeland security, natural disasters, public emergencies, wanted persons and missing persons.

It is a further object of this invention to provide an outdoor message system that provides timely information of an urgent public nature to persons not otherwise having access or paying attention to conventionally available broadcast media.

It is a further object of this invention to provide a system for efficiently and economically establishing and funding a plurality of centrally controlled, digitally broadcast message boards which provide timely information of an urgent public nature to members of the public traveling on the highway or otherwise in an outdoor public venue.

This invention features an outdoor digital broadcast message system comprising a network of prominent outdoor display panels mounted along and visible from respective public highways or other public venues. The panels project high-resolution digital photographic and video images, as well as textual messages that can be readily seen by persons traveling along the highway or located in the public venue. The boards are operated by a central controller that is programmed to deliver selected messages and images to the respective boards. The controller is programmed to specifically send messages concerning significant issues of public interest such as homeland security, missing persons, natural disasters, wanted persons and public emergencies.

In a preferred embodiment, the display panel employs color LED technology utilizing LED clusters, which may be on 0.6″ centers or otherwise arranged to provide a high-resolution display. A variety of alternative centers may be utilized. Messages may be directed to each board from the controller by various communication means including the Internet, optical fibers, wireless communication, satellite, etc. The central controller for the network of display panels may be nationally based or may be located in a particular region of the country for controlling boards in that region. Gas plasma, LCD displays or television monitors may be employed for indoor venues, such as airport terminals and shopping malls. Laser and projection screen technology also may be employed. Portable and fixed panels may be utilized.

The display panel may be interiorly illuminated and preferably employs 100% solid-state electronics. The panel is typically mounted between a pair of pylons. The panel may be mounted in a cabinet and the cabinet and mounted pylons may be shrouded in black. Advertising on the message board may feature an exteriorly illuminated tri-vision advertising panel. LED diodes are illuminated from within.

Various numbers and arrangements of display panels may be utilized. A redundant power system with alternative back-up power supplies is preferably employed.

To fund the foregoing system, sponsorships may be sold. Sponsor's names may be carried on or proximate to the display panel. When the system is employed by the government, such sponsorship will significantly reduce the need for using tax dollars to pay for the messaging system.

### DETAILED DESCRIPTION OF PREFERRED EMBODIMENT

Other objects, features and advantages will occur from the following description of a preferred embodiment and the accompanying drawings, in which:

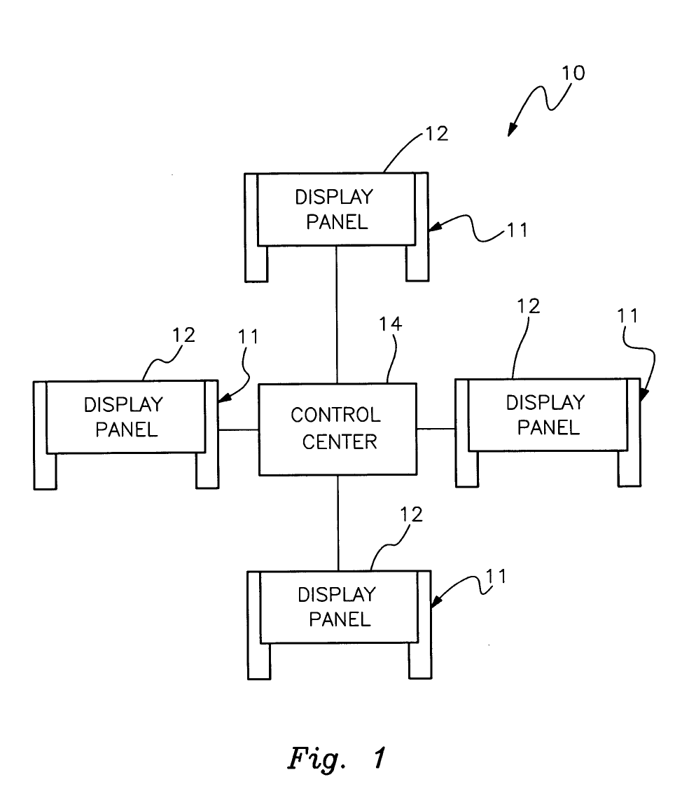

FIG. 1 is schematic view of an outdoor digital broadcast message system according to this invention;

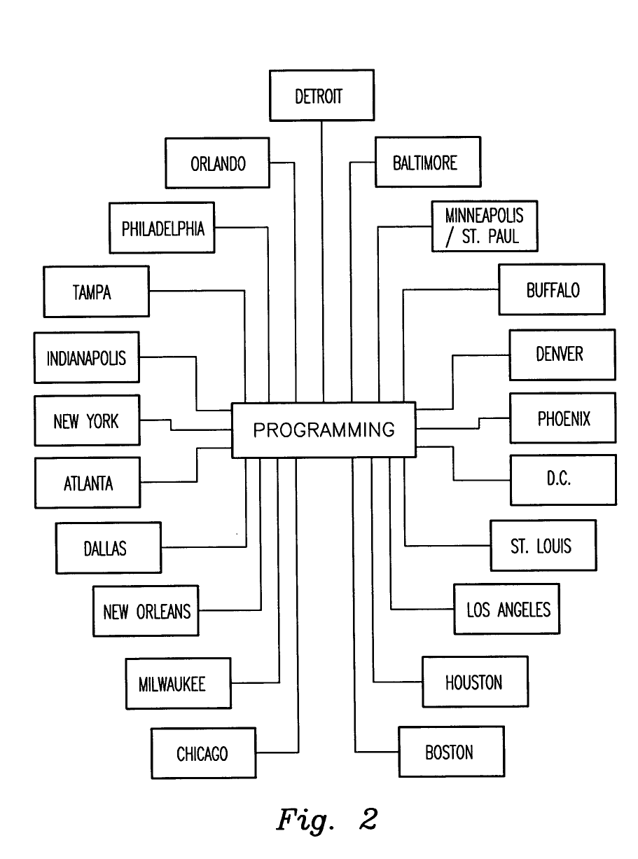

FIG. 2 is a schematic view depicting a representative network of display panels situated in major metropolitan areas according to this invention; and

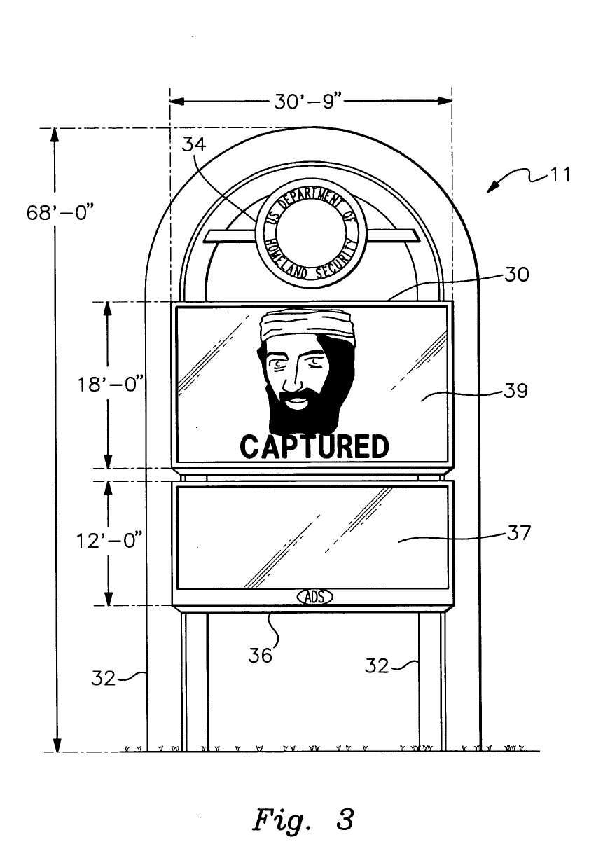

FIG. 3 is a perspective view of a preferred display panel of the type used in the message system.

There is shown in FIG. 1 an outdoor digital broadcast message system 10 including a plurality of digital message boards 11 situated at predetermined outdoor locations, such as along respective public roadways, typically an interstate, expressway or divided highway, or in public venues such as airports, bus/train stations and outdoor arenas and stadiums. Each board carries a high-resolution digital display panel 12 that is electronically controlled by a computerized control center 14. The number of digital display panels that may be utilized in the system is not a limitation of this invention. The system may include a network of virtually any number of interconnected display panels. An effective nationwide network may preliminarily comprise one hundred and fifty to two hundred or more display panels located in major metropolitan areas, as depicted in FIG. 2. Once again, the locations may be altered within the scope of this invention. Moreover, larger metropolitan areas (e.g. New York, Chicago) may include a greater number of display panels, whereas smaller metropolitan areas (e.g. Buffalo, New Orleans) may include lesser numbers. The system may also be used effectively in international locations, North America and elsewhere.

A representative display panel 12 is depicted in FIG. 3. Each display panel comprises an 18′×30′9″ array of LED (light emitting diode) clusters located on centers of approximately 0.6″ Color LED technology is utilized and the display sign may feature a 352×608 point matrix. The signage should be capable of providing full colors beyond 16.7 million. The display panel is interiorly illuminated and is encased within a standard cabinet 30 of the type presently used in outdoor display signage. The display cabinet is mounted on a pair of pylons 32 that are interconnected to define an inverted U-shape mounting structure. A logo, e.g. “US Department of Homeland Security” 34 may be mounted above display panel 30 and a corporate sponsorship banner 36 may be mounted below the display sign. Alternatively, a lower section 37 of the panel may broadcast text messages and an upper section 39 may broadcast photographic and video images and optional text. In either case, a high-resolution digital display is employed. The dimensions and components of the digital message board shown in FIG. 2 are representative only and may be varied within the scope of this invention. In any even, the message board should be tall enough so that it is clearly optically visible to persons driving along an adjacent highway or in other public venues in which the message board may be mounted. The display cabinet and pylons may be shrouded or painted in black to improve the visibility and resolution of the digitally broadcast images. In alternative embodiments, other forms of electronics, including but not limited to gas plasma and television, may be employed within the scope of this invention.

The 18′×30′ array of diodes is only one of many possible ways of accomplishing the invention. The ability to dim the diodes independently creates the number of colors and shades associated with photos and videos. Again, the interior illuminated panel is only for the Homeland Security panel or other message panel. LED technology is the primary source of lighting. However, a different array using gas plasma, LCD, projection screen, laser or other types of lighting may be utilized, especially for interior systems such as airports and shopping centers. The panels may be fixed or portable.

Control center 11, FIG. 1 comprises a computer system that is programmed to direct digital video, photographic and textual messages to each of the display panels 12 in the network. Various known types of computer systems may be utilized. Typically, the computer is programmed to generate messages having a public interest, including messages relating to homeland security, missing persons, wanted/suspected individuals, natural disasters and public emergencies. Appropriate notices, warnings and status reports may be sent periodically or as needed to the display panels. The system may be programmed so that each of the panels in the network receives and broadcasts the same message simultaneously. Alternatively, the control center may be programmed to direct a different or custom message to an individual display panel or to the display panels within a selected region. The system provides the flexibility for various forms of messaging to the respective display panels.

Each display panel incorporates the high-resolution digital LED technology described above so that extremely high quality photographic and video images are transmitted and broadcast over the display panels. This allows people traveling along a highway to receive information accurately, unambiguously and virtually instantaneously. Homeland security and other public concerns are thereby effectively addressed and much faster than is currently accomplished. The public is apprised immediately of on-going developments in a particular area much more effectively than has previously been provided. National security and public safety are thereby improved significantly.

Because digital messages are send from the control center to the respective display panels, various means of communication may be employed. For example, the signals may be sent via the Internet, wireless communication, satellite, etc. Because the display panels employ solid-state electronic components, any such signals are conveniently received and translated into high quality video, photographic and textual images. This digital broadcast message system may be used for various governmental and nongovernmental purposes. For example, the government may broadcast the images of suspected and/or apprehended terrorists and may otherwise provide homeland security information and status reports. The federal or a local government may provide emergency and natural disaster information, such as evacuation directions. The Federal Bureau of Investigation and other police agencies may employ information concerning the identity and status of wanted persons. Local, state and federal government agencies may broadcast information concerning missing children and adults. Homeland security education programs sponsored by the federal, state or local governments may also be broadcast.

In certain cases, broadcast video or photographic images may be accompanied by government radio transmissions. A wide variety of public service information may also be transmitted.

As previously described, a portion of the message board may include a sponsorship panel. Corporations and other entities may purchase periodic or permanent sponsorships. Such sponsorships will help to fund the construction and operation of the systems and the network of panels incorporated therein.

The display panels will be programmed at the control center, using conventional and proprietary programming techniques, to provide the messaging required. The board shall be maintained and serviced likewise to accomplish the process of this invention.

From the foregoing it may be seen that the apparatus of this invention provides for an outdoor or indoor digital messaging system for broadcasting high-resolution photographs and video messages from a control center to a plurality of display panels.

While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

Other embodiments will occur to those skilled in the art and are within the following claims:

1. A digitally broadcast messaging system comprising:
a network of display panels mounted proximate to and visible from respective venues occupied, at least temporarily, by members of the public; each said panel capable of displaying high-resolution digital photographic and video images, as well as textual messages to persons in the respective venues; and
a controller programmed to electronically deliver to said panels signals representative of images and text relating exclusively to issues of public interest, said display panels including electronic components for translating said signals into corresponding images and text, which are displayed in a selected manner on said panels.

2. The system of claim 1 in which each said display panel includes color LED clusters.

3. The system of claim 1 in which said display panels include at least one of the group consisting of LED screens, LCD screens, plasma screens, laser screens, projection screens and television monitors.

4. The system of claim 1 in which said signals are transmitted from said controller to said panels by one of the group consisting of internet transmission, optical fibers, wireless and satellite transmission.

5. The system of claim 1 in which said display panels employ solid state electronics for translating said signals into corresponding images and text.

6. The system of claim 1 in which said panels are interiorly illuminated.

7. The system of claim 1 in which multiple panels are located at respective locations geographically distinct from one another.

8. The system of claim 1 in which at least one panel includes a first section for displaying images and a distinct second section for displaying textual messages.

9. The system of claim 1 in which said display panel carries advertising signage for indicating a sponsor of said panel.

10. A method of a governmental or quasi-governmental agency transmitting video, photographic and textual messages relating to matters of public interest to members of the public, said method comprising:
installing a network of display panels such that said panels are visible from respective public venues occupied, at least temporarily, by member of the public;
providing each panel with the capability of displaying high-resolution, digital, photographic and video images, as well as textual messages;
delivering from a governmental or quasi-governmental agency to one or more of said panels electronic signals representative of images and text relating to matters of public interest; and
translating said signals into corresponding images and text, which are displayed on said one or more panels such that members of the public in the respective public venues are given visual access to the matters of public interest.

11. The method of claim 10 including installing the display panels in at least one public venue from the group consisting of public roadways, airport terminals, stadia, arenas, train stations, subway stations and bus terminals.

12. The method of claim 10 including delivering to said panels signals representative of image and text relating to matters of public interest from the group consisting of homeland security, wanted persons, missing persons, weather alerts, traffic alerts and natural disasters.
